(19) United States
(12) Patent Application Publication
(10) Pub. No.: US 2026/0309581 A1
(43) Pub. Date: Oct. 8, 2026

(54) CHARACTERIZING STRUCTURAL AND GEOMETRIC PROPERTIES OF OPTICAL FIBERS

(71) Applicant: CORNING INCORPORATED, CORNING, NY (US)

(72) Inventor: Riley Saunders Freeland, Corning, NY (US)

(21) Appl. No.: 19/441,169

(22) Filed: Jan. 6, 2026

Related U.S. Application Data
(60) Provisional application No. 63/744,539, filed on Jan. 13, 2025.

(51) Int. Cl. G01M 11/00; G02B 6/02

(52) U.S. Cl. CPC G01M 11/31; G02B 6/02328

(57) ABSTRACT

Aspects of the disclosure provide a method of characterizing an optical fiber, the method including: generating a coordinate point representation of an image comprising a cross-section of the optical fiber, the coordinate point representation comprising a series of edge points; determining, based on the series of edge points, a circular primary structure within the generated coordinate point representation; generating a first best-fit rounded shape corresponding to a series of inner edge points and a second best-fit rounded shape corresponding to a series of outer edges points of the circular primary structure; for each respective detected circular sub-structure, generating a series of subsequent best-fit rounded shapes corresponding to inner edge points and outer edge points of the respective detected circular sub-structure; and calculating a structural property of the optical fiber based on at least one of the generated first best-fit rounded shape, second best-fit rounded shape, and subsequent best-fit rounded shapes.

This application claims the benefit of priority to U.S. Provisional Patent Application Ser. No. 63/744,539 filed on Jan. 13, 2025, the content of which is relied upon and incorporated herein by reference in its entirety.

### FIELD

Aspects of the present disclosure relate to methods of characterizing structural and geometric properties of optical fibers and, more specifically, hollow-core optical fibers, anti-resonant hollow-core optical fibers, and/or nested anti-resonant hollow-core optical fibers.

### TECHNICAL BACKGROUND

The performance of a given manufactured optical fiber is highly dependent on the geometry of the structure in its final form. For example, in the manufacturing of antiresonant hollow-core optical fibers, the thickness of fine capillary walls, the gaps between capillaries, and the position of smaller nested capillaries can influence optical properties of attenuation, high-order mode loss, bend loss, and mode field diameter. Companies that manufacture optical fibers constantly strive to employ techniques that more effectively characterize a given fiber's structural and geometric properties at various states during a given manufacturing process.

### SUMMARY

According to a first aspect A1, a method of characterizing an optical fiber may include: generating a coordinate point representation of an image comprising a cross-section of the optical fiber, the generated coordinate point representation comprising a series of edge points; determining, based on the series of edge points, a circular primary structure within the generated coordinate point representation having a largest diameter; generating a first best-fit rounded shape corresponding to a series of inner edge points and a second best-fit rounded shape corresponding to a series of outer edges points of the circular primary structure; detecting one or more circular sub-structures within the first best-fit rounded shape; for each respective detected circular sub-structure of the one or more detected circular sub-structures, generating a series of subsequent best-fit rounded shapes corresponding to respective inner edge points and respective outer edge points of the respective detected circular sub-structure; and calculating a structural property of the optical fiber using values based on at least one of the generated first best-fit rounded shape, second best-fit rounded shape, and subsequent best-fit rounded shapes.

A second aspect A2 includes the method of the first aspect A1, further comprising: pre-processing the received image by at least smoothing the received image; and performing derivative filtering of the received image.

A third aspect A3 includes the method of any preceding aspect, further comprising: detecting noise associated with at least the primary circular structure or one or more of the respective detected circular sub-structures in the received image; and removing the detected noise.

A fourth aspect A4 includes the method of any preceding aspect, further comprising: detecting at least a first plotted sub-structure having a second plotted sub-structure contained within the bounds of the first plotted sub-structure; and maintaining a hierarchical relationship between the at least first plotted sub-structure and the second plotted sub-structure by assigning hierarchical reference tags to the first plotted sub-structure and the second plotted sub-structure.

A fifth aspect A5 includes the method of any preceding aspect, wherein the received image is obtained using a non-destructive sampling method.

A sixth aspect A6 includes the method of any preceding aspect, wherein the circular sub-structures correspond to one or more of a capillary and a nested capillary.

A seventh aspect A7 includes the method of any preceding aspect, wherein the fiber comprises a hollow-core fiber.

An eighth aspect A8 may include a processing system, comprising: a memory comprising computer-executable instructions; and a processor configured to execute the computer-executable instructions and cause the processing system to perform a method in accordance with any of preceding aspects A1-A7.

A ninth aspect A9 may include a computer program product embodied on a computer-readable storage medium comprising code for performing a method in accordance with any of preceding aspects A1-A7.

Additional features and advantages of the methods of determining structural properties of optical fibers will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The appended figures depict certain aspects and are therefore not to be considered limiting of the scope of this disclosure.

FIG. 1 depicts an example of system architecture usable for performing described methods of characterizing structural and geometric properties of an optical fiber according to at least one aspect.

FIG. 2 schematically depicts a cross-sectional view of an example hollow-core optical fiber drawn from a hollow-core preform that may be characterized by illustrative process of characterizing structural and geometric properties of an optical fiber according to at least one aspect.

FIG. 3A depicts an operational flowchart for an illustrative process of characterizing structural and geometric properties of an optical fiber according to at least one aspect.

FIG. 3B depicts an operational flowchart for an illustrative process of characterizing structural and geometric properties of an optical fiber according to at least one aspect.

FIG. 4 depicts an example of a received image usable for performing described methods of characterizing structural and geometric properties of an optical fiber according to at least one aspect.

FIG. 5 depicts an example coordinate representation of the received image of FIG. 4 that may be generated using described methods of characterizing structural and geometric properties of an optical fiber according to at least one aspect.

FIG. 6 depicts an example coordinate representation of a circular sub-structure corresponding to a capillary of the optical fiber of FIG. 4.

FIG. 7 depicts an intermediate state showing the circular sub-structure of FIG. 6 having a series of determined inner edges and outer edges highlighted.

FIG. 8 depicts an intermediate state including an example of a best-fit ellipse corresponding to the inner edge of the circular sub-structure depicted in FIGS. 6-7 generated by performing described methods of characterizing structural and geometric properties of an optical fiber according to at least one aspect.

FIG. 9 depicts a diagrammatic view of a cross-section of a portion of an illustrative optical fiber showing an angular error measurement for an illustrative capillary according to at least one aspect.

FIG. 10 depicts a diagrammatic view of a cross-section of a portion of an illustrative optical fiber showing a wall thickness measurement for a wall of an illustrative capillary according to at least one aspect.

FIG. 11 depicts a diagrammatic view of a cross-section of a portion of an illustrative optical fiber showing a separation measurement between two illustrative capillaries according to at least one aspect.

FIG. 12 depicts a first line graph including structural properties of the optical fiber of FIG. 4 that may be generated by described methods of characterizing structural and geometric properties of an optical fiber according to at least one aspect.

FIG. 13 depicts a second line graph including structural properties of the optical fiber of FIG. 4 that may be generated by described methods of characterizing structural and geometric properties of an optical fiber according to at least one aspect.

FIG. 14 depicts an example of an output of a structural characterization system configured to perform described methods of characterizing structural and geometric properties of an optical fiber according to at least one aspect.

FIG. 15 depicts an example of a processing system in which a system for characterizing structural and geometric properties of an optical fiber according to at least one aspect according to at least one aspect may be implemented.

### DETAILED DESCRIPTION

Reference will now be made in detail to embodiments of methods, systems, and computer readable mediums for characterizing the structural and geometric properties of an optical fiber, examples of which are illustrated in the accompanying drawings. Whenever possible, the same reference numerals will be used throughout the drawings to refer to the same or like parts. According to embodiments, a method for determining the diameter a hollow core optical fiber includes generating a coordinate point representation of an image comprising a cross-section of the optical fiber, the generated coordinate point representation comprising a series of edge points; determining, based on the series of edge points, a circular primary structure within the generated coordinate point representation having a largest diameter; generating a first best-fit rounded shape corresponding to a series of inner edge points and a second best-fit rounded shape corresponding to a series of outer edges points of the circular primary structure; detecting one or more circular sub-structures within the first best-fit rounded shape; for each respective detected circular sub-structure of the one or more detected circular sub-structures, generating a series of subsequent best-fit rounded shapes corresponding to respective inner edge points and respective outer edge points of the respective detected circular sub-structure; and calculating a structural property of the optical fiber using values based on at least one of the generated first best-fit rounded shape, second best-fit rounded shape, and subsequent best-fit rounded shapes. Various aspects of methods systems, and computer readable mediums for characterizing the structural and geometric properties of an optical fiber will be described herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As previously discussed, the performance of a given manufactured optical fiber is highly dependent on the geometry of the structure in its final form. Accurate characterization of an optical fiber's structural and geometric properties helps ensure consistency in manufacturing, allows for improved control over production processes, and enables development of optical fibers for specific applications. Accurate characterization of the structural and geometric properties of optical fibers also helps to more accurately predict how certain fibers may behave under various conditions, allowing for improved product performance, reduced material waste, and enhanced efficiency during production. Other uses for structural and geometric characterization information of fibers may include: process tuning, feedback for modeling (optical, mechanical, thermal, etc.), part characterization, or variability estimation. In turn, companies that manufacture optical fibers constantly strive to employ techniques that more effectively characterize a given optical fiber's structural and geometric properties at various states during a given manufacturing process.

However, effectively characterizing a given optical fiber's structural and geometric properties involves numerous challenges. For example, certain tools and techniques for characterizing structural and geometric properties of optical fibers are only capable of processing simple shapes, such as circles. This prevents accurate characterization of optical fibers involving structures having non-uniform or irregular shapes with any consistency. Additionally, there may be variability in cross-sectional shape, surface texture, or diameter along the length of a given segment of optical fiber, complicating measurement. Other tools or techniques for characterizing structural and geometric properties of optical fibers may rely upon manual input from humans. For example, some cross-sectional analysis tools may involve a user manually clicking on edge features, forcing the operator to point-and-click to measure feature sizes, leading to uncertainty and variability due to user error with regard to precision and accuracy of the clicks. These challenges are further exacerbated as the dimensions of manufactured optical fibers are scaled down to the micro or even nano scale. Additionally, extraneous elements or noise can inhibit effective characterization of a given optical fiber's structure and geometry, particularly where certain structures or elements may overlap or otherwise contact each other along the length of the optical fiber. Furthermore, certain types of manufactured optical fibers, such as microstructured, multicapillary, or bicontinuous optical fibers may include numerous capillaries and nested capillaries extending in parallel along the length of the optical fiber. Some conventional tools and techniques for characterizing structural and geometric properties of optical fibers are also ineffective for presenting structural and geometric features of sub-structures within an optical fiber in a way that maintains the relationships between the sub-structures of a given optical fiber. Lastly, certain tools or techniques for characterizing structural or geometric properties of optical fibers are solely usable via destructive sampling techniques that may not be feasible or desirable depending on the manufacturing process.

Accordingly, described aspects provide methods, systems, and computer-readable mediums for automatically characterizing structural and geometric properties of optical fibers by isolating and fitting complex shapes to image features to extract accurate data for circular structure and sub-structures within a target optical fiber.

Described aspects include structural characterization systems that provide technical improvements over conventional methods of characterizing structural and geometric properties of optical fibers. Described aspects automatically characterize structural and geometric properties of an optical fiber by processing images of cross-sections of optical fibers. Described aspects thus remove manual operators from the loop, eliminating reliance on a user manually clicking on edge features, or using point-and-click methods to measure feature sizes. In turn, described structural characterization systems lead to increased certainty and precision, and less variability due to the absence of any user error, particularly as the size of a given target optical fiber decreases. Additionally, described aspects include methods of pre-processing images and removing extraneous elements or noise at multiple points during characterization of a given optical fiber. This provides for increased accuracy and precision in generating best-fit rounded shapes to represent inner and outer edges of a given structure or sub-structure within a target optical fiber, which in turn, allows for more effective characterization of the optical fiber's structural and geometric properties when the rounded shapes are utilized downstream for calculating and measuring various structural and geometric features of the optical fiber. Furthermore, described aspects efficiently characterize structural and geometric properties of optical fibers including structure and sub-structures having irregular shapes, such as rounded shapes deviating from characteristics of perfect circles. More specifically, described aspects leverage two-dimensional coordinate representations of received images to determine edge points of inner and outer edges of respective structures, allowing for downstream generation of best-fit rounded shapes that most accurately characterize the structural and geometric properties of the fiber being considered. This provides increased accuracy when extracting structural and geometric properties over conventional tools and techniques that are incapable of processing irregular shapes. Additionally, by iteratively or recursively generating best-fit rounded shapes for inner and outer edges of each structure and sub-structure in a given optical fiber being considered, described aspects can effectively maintain a nesting hierarchy of features for related structures (e.g., preserving how the features of a nested capillary compare to a parent capillary in which the nested capillary is positioned), allowing for improved and more comprehensive understanding of structural and geometric properties of a given optical fiber. Furthermore, described aspects provide for improved flexibility regarding available testing or sampling methods. For example, in addition to being able to process received images obtained using destructive sampling methods, described aspects may also process received images obtained using non-destructive sampling methods, such as X-ray images of optical fibers. Thus, described aspects may be used to characterize structural and geometric properties of a target optical fiber along its length without the downside risk associated with destructive sampling methods. It may be appreciated that described aspects may also be used to characterize structural and geometric properties of a given optical fiber at different stages of manufacturing various optical fibers. For example, described aspects may be used to characterize structural and geometric properties of a cane, a blank, or other intermediate pre-form structures for manufacturing a given optical fiber. The samples may be collected at multiple points along a given optical fiber (or intermediate structure associated with manufacturing of a given optical fiber) to assess non-uniformity or variability along the length of the sample.

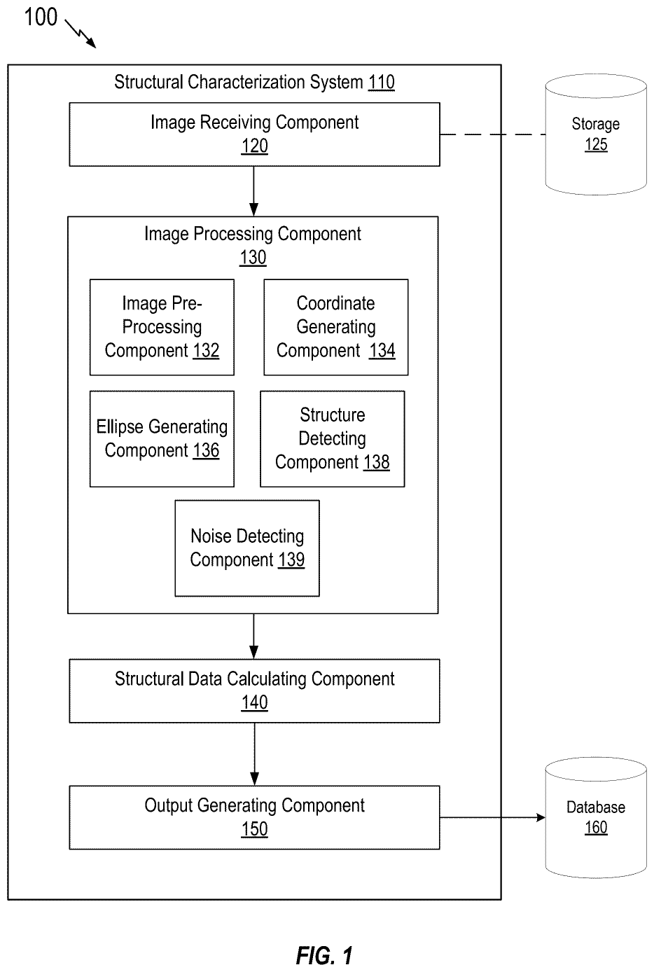

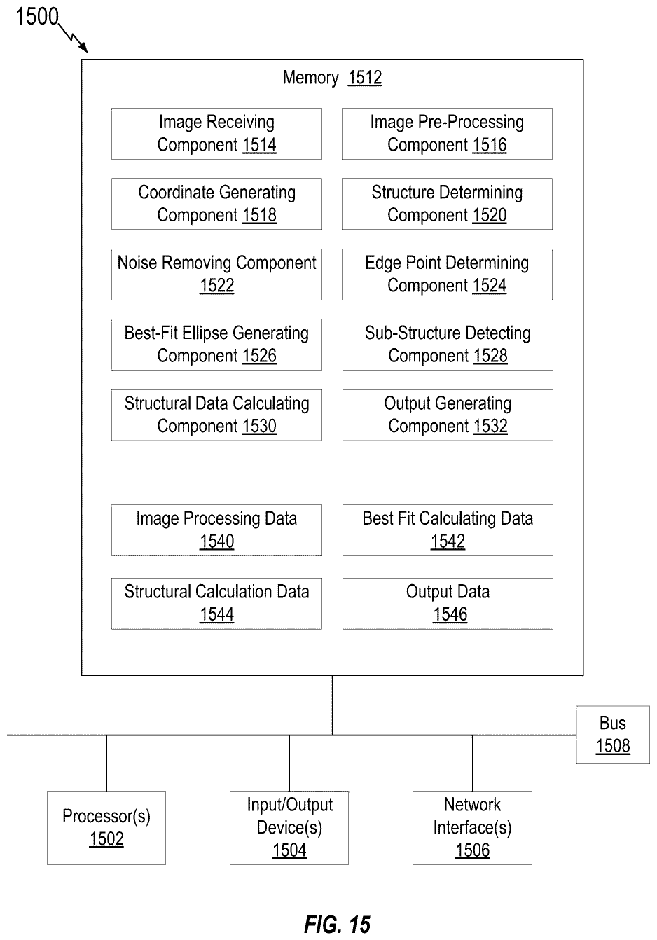

FIG. 1 depicts illustrative system architecture 100 usable for performing described methods of characterizing structural and geometric properties of an optical fiber according to at least one aspect. In FIG. 1, system architecture 100 includes a structural characterization system 110 capable of performing methods described herein to characterize structural and geometric properties of a given optical fiber. Structural characterization system 110 includes an image receiving component 120 for receiving or storing cross-section images of an optical fiber to be characterized by structural characterization system 110. Image receiving component 120 may optionally fetch one or more storage images from an accessible storage 125 for storing images of preforms or optical fibers to be characterized. Structural characterization system 110 further includes an image processing component 130 for processing received images. Image processing component 130 may be configured to process images of a variety of different formats as may be suitable for different imaging techniques. Image processing component 130 further includes components configured to perform various image processing functions, such as image pre-processing component 132 for pre-processing received images, coordinate generating component 134 for generating two-dimensional coordinate representations of received images, ellipse generating component 136 for generating best-fit ellipses based on coordinate point representations inner and outer edges of detected circular structures, structure detecting component 138 for detecting circular structures and sub-structures within a given optical fiber, and noise detecting component 139 for detecting and removing extraneous points or noise. In certain aspects, ellipse generating component 136 may be substituted with a rounded shape generating component configured to generate one or more different best-fit rounded shapes according to stored programs or instructions (for example based on leveraging instructions and mathematics corresponding to data stored within best fit calculating data 1542 of memory 1512 with reference to FIG. 15). As used herein, a “rounded shape” refers to any shape having a perimeter, where at least 50-60% of the perimeter lacks a vertex. “Rounded shapes” may include, but are not limited to circles, ovals, or any other irregular shapes resembling a circle. As used herein an “oval” may include any shape having an enclosed area with a rounded boundary. In some examples, an “oval” may include any rounded shape having an aspect ratio less than or greater than 1, such as based on dividing the height and the width of a smallest rectangular bounding box for fully containing a given oval. In certain examples, an “oval” may include any ellipse having non-zero eccentricity.

Structural characterization system 110 further includes a structural data calculating component 140 for calculating and measuring geometric and structural properties of a target optical fiber associated with a received or stored image utilizing generated best-fit rounded shapes. Structural characterization system 110 also optionally includes an output generating component 150 for generating reports including information corresponding to the calculated and measured geometric and structural properties of the target optical fiber. Described aspects may generate reports that further include plots, graphs, tables, images, or other structures or analysis tools for conveying information related to the calculated and measured geometric and structural properties of a target optical fiber. In some examples, output generating component 150 may generate reports including raw data (e.g. unprocessed measurements), geometric analysis (e.g. processed measurements), statistical summaries (e.g. aggregated statistics for characterizing structures within a given fiber), comparative reports, quality control reports (e.g. pass/fail results for a given optical fiber based on predetermined thresholds for different metrics), and any other report types as may be useful for presenting information associated with data and measurements processed by described aspects. Output generating component 150 of structural characterization system 110 may further be configured to send data corresponding to generated plots, reports, and images to a database 160 for storage.

Structural characterization system 110 may be employed to characterize geometric and structural properties of any suitable optical fiber. Structural characterization system 110 may be particularly useful for characterizing structural properties of optical fibers featuring capillaries and nested capillaries, such as microstructured optical fibers, multicapillary optical fibers, bicontinuous optical fibers, and hollow-core optical fibers. Structural characterization system may implemented using an example processing system (such as illustrative processing system 1500 described below with reference to FIG. 15) include one or more processors and one or more non-transitory computer-readable mediums storing computer readable instructions that, when executed by the one or more processors, cause the one or more computing devices to perform processes defined by computer-readable instructions corresponding to one or more components depicted and described herein.

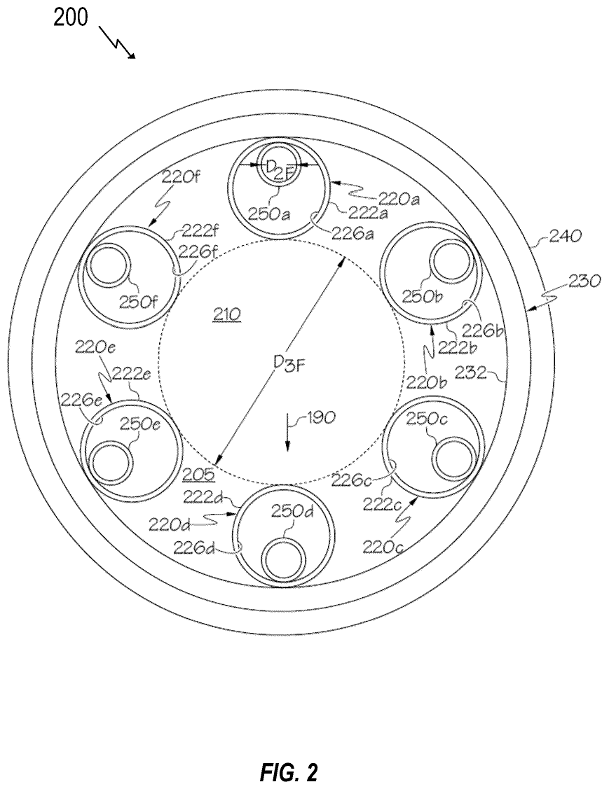

FIG. 2 schematically depicts a cross-sectional view of an illustrative hollow-core optical fiber 200 drawn from a hollow-core preform. The hollow-core optical fiber 200 may be characterized using illustrative processes of characterizing structural and geometric properties of an optical fiber according to at least one aspect. Hollow-core optical fiber 200 includes an overclad 240 in contact with an outer surface of a substrate 230. The region associated with diameter D_{3f} is a hollow section, which defines the hollow core 210 of the hollow-core optical fiber 200. In aspects, at least one capillary 220 in the hollow-core optical fiber 200 may include a nested capillary 250. As described herein, a “nested capillary” refers to a capillary positioned within another capillary such that an exterior surface of the nested capillary is connected to an interior surface of the other capillary. In aspects, the nested capillary 250 may directly contact an interior surface 226 of the wall 222 of the capillary 220. For example, in the aspect depicted in FIG. 2, nested capillary 250a is in direct contact with an interior surface 226a of the wall 222a of capillary 220a. In aspects, each capillary 220 in the hollow-core optical fiber 200 may include a nested capillary 250 (i.e, nested capillaries 250a, 250b, 250c, 250d, 250e, and 250f in the aspect depicted in FIG. 2).

In aspects, the nested capillaries 250 may be directly or indirectly connected to the interior surface 226 of the wall 222 of the capillary 220 at a point proximate to the inner surface of the substrate 230. As described herein, a point may be proximate to the substrate 230 when it is the closest point to the substrate 230 evaluated in a radial direction 190 extending from the center of hollow core 210. In aspects, a nested capillary 250 may be directly or indirectly connected to the interior surface 226 of the wall 222 of the capillary 220. For example, without limitation, a nested capillary 250 may be directly or indirectly connected to the interior surface 226 of the wall 222 of the capillary 220. Hollow-core optical fiber 200 is merely a non-limiting example of the various optical fibers which may be characterized using described methods.

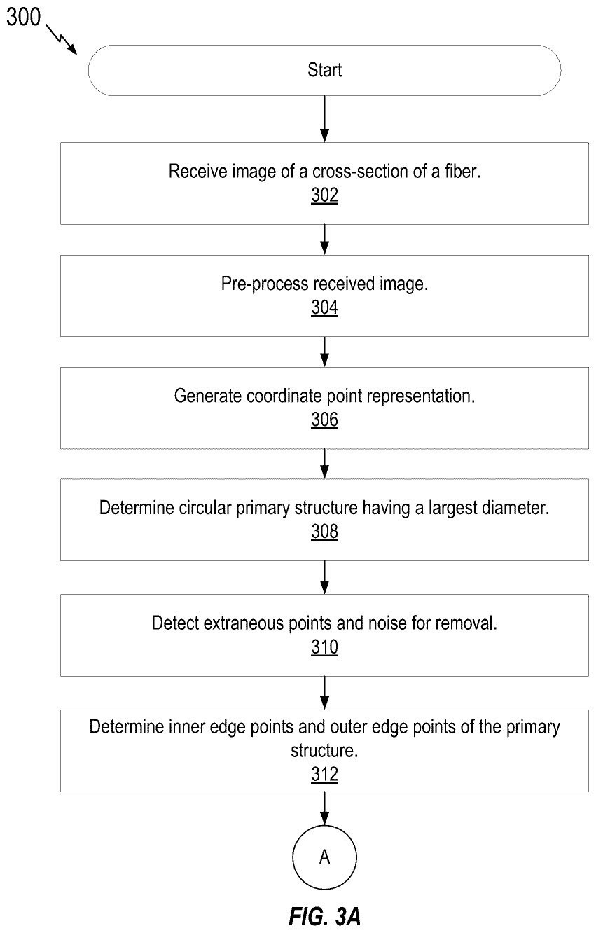

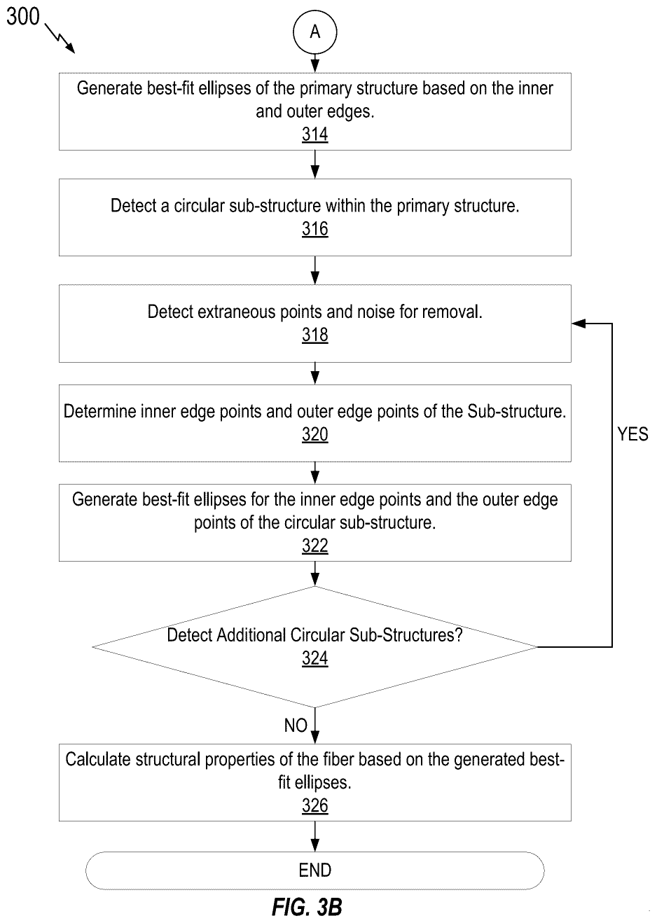

FIGS. 3A and 3B depict operational flowcharts for an illustrative process 300 of characterizing structural and geometric properties of an optical fiber performable by a structural characterization system (such as structural characterization system 110, as described above with reference to FIG. 1) according to at least one aspect.

At block 302, structural characterization system 110 receives an image including a cross-section of an optical fiber, such as an image of a cross section of the hollow-core optical fiber 200 depicted in FIG. 2. In aspects, an image receiving component (such as image receiving component 120 of FIG. 1) of structural characterization system 110 may be configured to receive images derived from a variety of image sources and optical fiber sampling methods. For example, the image receiving component of structural characterization system 110 may be configured to receive images obtained using a suitable camera, optical microscopy (e.g., brightfield and polarized light microscopy), scanning electronic microscopy (SEM), transmission electron microscopy (TEM), X-Ray, X-Ray microtomography, ultrasonic imaging, machine vision systems, and various other suitable sampling techniques for obtaining cross-section images of optical fibers. Accordingly, structural characterization system 110 may be used to process cross-section images of optical fibers that may be obtained using destructive, or non-destructive sampling methods. The ability of described aspects to receive images derived from different sources allows for improved flexibility, and the ability to effectively characterize geometric and structural properties of optical fibers along their length when using non-destructive sampling methods, such as X-Ray microtomography. Additionally, described aspects may receive images derived from different sampling techniques that are more suitable for sampling different types of optical fibers or intermediate structures for manufacturing optical fibers. For example, using X-ray may be more suitable for sampling larger structures such as canes or blanks. In certain aspects, structural characterization system 110 may instead be configured to fetch an image

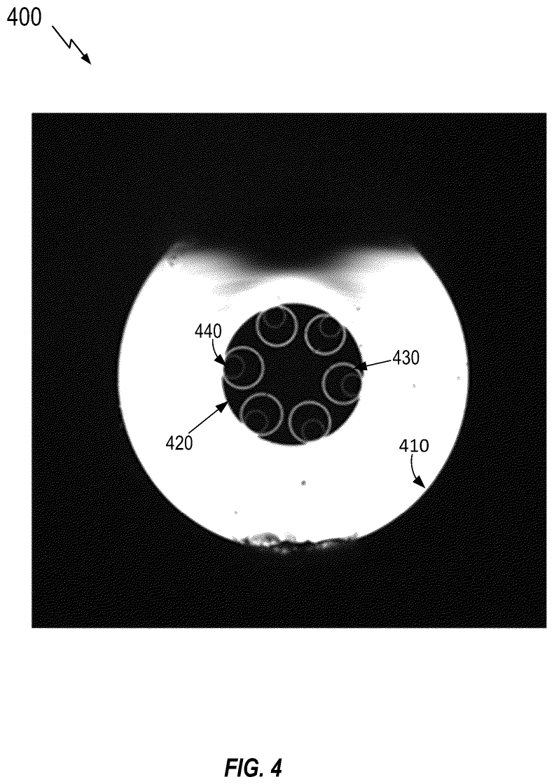

By way of example, FIG. 4 depicts an example received image 400 usable for performing described methods of characterizing structural and geometric properties of an optical fiber according to at least one aspect. More specifically, received image 400 depicts a cross-sectional view of the end of a hollow-core optical fiber obtained using an optical microscope. Received image 400 includes a circular primary structure 410 having a largest diameter and corresponding to the outer diameter of the glass portion of the hollow-core optical fiber, a secondary circular sub-structure 420 corresponding to the inner diameter of the hollow-core optical fiber, six capillaries 430 and six nested capillaries 440 that are positioned within each respective capillary 430. As used herein, the term “circular” encompasses deviations from strict mathematical circularity due to, for example, variability or tolerances in manufacturing.

Referring again to FIGS. 3A and 3B, at block 304, illustrative process 300 continues with structural characterization system 110 pre-processing the received image. For example, an image pre-processing component of an image processing component (such as image pre-processing component 132 of image processing component 130 in FIG. 1) of structural characterization system 110 may pre-process an image by employing various techniques. Illustrative techniques for pre-processing the received image may include, but are not limited to, techniques for smoothing, cropping (such as cropping image text blocks or borders), contrast enhancement, derivative filtering, normalization of pixel intensity values, resizing and scaling, and noise removal. As used herein, “image smoothing” refers to any known image smoothing techniques used to reduce noise and variations in a received image by averaging pixel values or applying filters, such as, for example, employing a Savitzky-Golay filter, Gaussian Blur techniques, Mean/Box filters, Median filters, high-pass, low-pass, and any other known combinations of filters for performing different tasks and smoothing techniques useful for pre-processing the received image to facilitate downstream analysis. As used herein, “derivative filtering” refers to any techniques involving calculating the rate of change of pixel intensities in an image to highlight edges or transitions between different regions, such as, for example, employing Sobel filters, Prewitt filters, Laplacian filters, gradient filters of a first or highest derivative order, or any other known derivative filtering techniques.

At block 306, structural characterization system 110 generates a coordinate point representation of the received image including a series of edge points. For example, a coordinate generating component of an image processing component (such as coordinate generating component 134 of image processing component 130 in FIG. 1) of structural characterization system 110 may convert the pre-processed received image to a coordinate point representation including a list of two-dimensional (2D) points by interpolating along each axis where the local image derivative is maximum, or equivalently, where the local edge second derivative (or Lorentzian) is equal to zero. The generated coordinate point representation is accordingly made up of 2D points representing individual pixel coordinates (of the received pre-processed image) in a two-dimensional grid defined by “x” and “y” values corresponding to edge points of structures within the optical fiber depicted in the received image. The generated coordinate point representation thus maps out the structure (shapes, features, geometry, etc.) of the edge points of structures and sub-structures of the optical fiber associated with the received image in a two-dimensional plane.

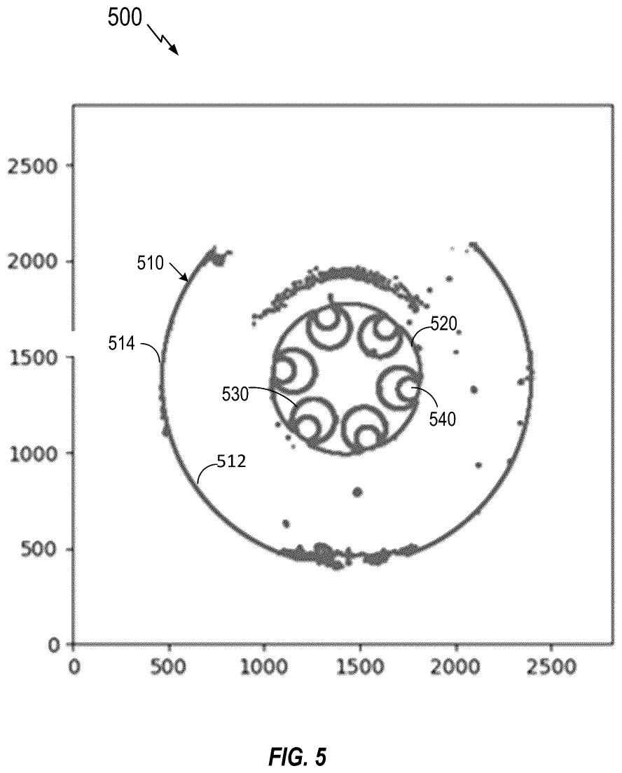

For example, FIG. 5 depicts an illustrative coordinate point representation 500 of the received image of FIG. 4 that may be generated using described methods of characterizing structural and geometric properties of an optical fiber according to at least one aspect. As shown, coordinate point representation 500 includes a series of edge points mapping out and forming a primary circular structure 510, a second circular sub-structure 520, and a series of capillaries 530, having a series of nested capillaries 540 contained therein.

Referring again to FIGS. 3A and 3B, at block 308, structural characterization system 110 determines, based on the series of edge points, a circular primary structure within the generated coordinate point representation having a largest diameter. Described aspects may utilize any known methods for detecting rounded shapes. For example, described aspects may employ Hough algorithms, radial symmetry transform (RST) techniques, or contour detection and approximation techniques. For example, a structure detecting component of an image processing component (such as structure detecting component 138 of image processing component 130 in FIG. 1) of structural characterization system 110 may process the generated coordinate point representation of the received image to determine a primary circular structure having a largest diameter. In FIG. 5, for example, structural characterization system 110 may determine that the primary circular structure 510 is the circular primary structure having the largest diameter (as compared to the other circular structures) within received image 400.

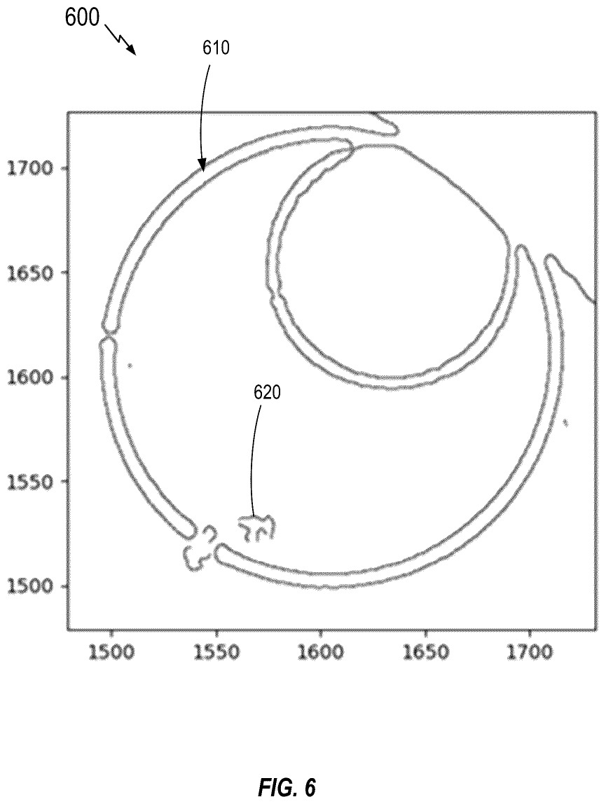

At block 310, structural characterization system 110 detects extraneous points and noise associated with the primary circular structure for removal. For example, a noise detecting component (such as noise detecting component 139 of image processing component 130) of structural characterization system 110 may employ suitable techniques for detecting and removing extraneous points and noise. As used herein “noise” refers to any extraneous visual information that distorts, obscures, or is unrelated to true structural details of a given primary structure or sub-structure within a target optical fiber that is the subject of a received image. Noise may include at least variations in pixel intensity (brightness or color), artifacts, artificial patterns, distortions, or other pixels of the received image unrelated to features of a given structure or sub-structure. Suitable techniques employable by structural characterization system 110 to remove extraneous points and noise may include at least the techniques described above in connection with pre-processing the received image at block 304. In aspects, structural characterization system 110 may be configured to detect, as noise associated with a given primary structure or sub-structure, any points in the generated coordinate point representation that are within a predetermined threshold distance from a series of point that make up a detected primary circular structure or circular sub-structure of the target optical fiber that is the subject of the received image. In aspects, the predetermined threshold distance employed by structural characterization system 110 may be adjusted or reconfigured. FIG. 6 depicts an illustrative coordinate point representation of a circular sub-structure 600 corresponding to a capillary 610 of the fiber of FIG. 4. As seen in FIG. 6, an extraneous structure 620 includes a series of extraneous points and noise which may be detected by structural characterization system 110, and subsequently removed at block 310 using suitable removal techniques.

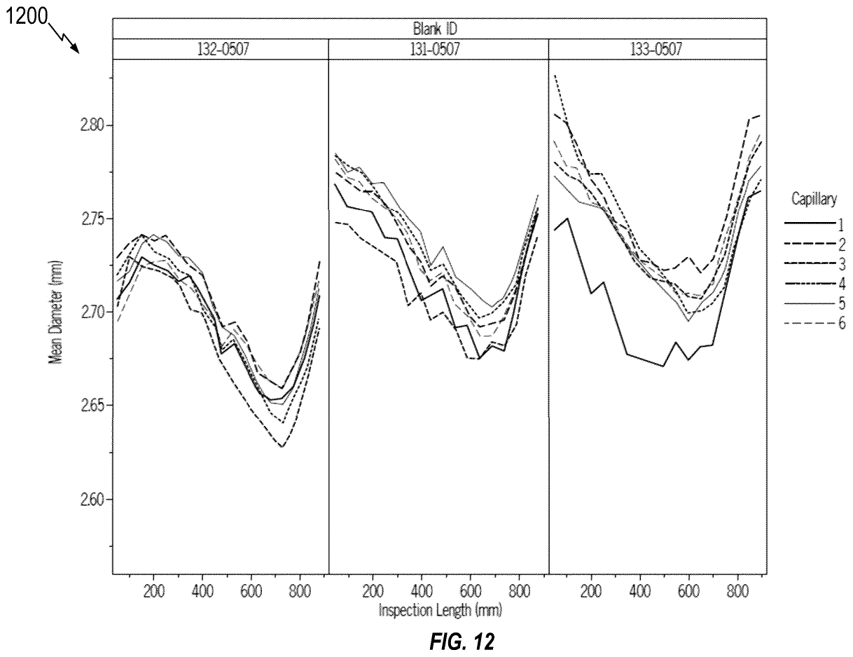

At block 312, structural characterization system 110 determines (for example, using edge point determining component 1224 with reference to FIG. 12) inner edge points and outer edge points of the circular primary structure. As used herein “inner edge points” refer to edge points of a given circular structure in the received image which are considered inward facing with respect to a center point of the circular structure being considered. Referring back to the primary circular structure 510 of FIG. 5, edge point pixels associated with edge points facing inward towards a center point of the primary circular structure within the generated coordinate point representation 500 are determined by structural characterization system 110 to be “inner edge points” of primary circular structure 510. As used herein “outer edge points” refer to edge points of a given circular structure in the received image which are considered outward facing with respect to a center point of the given circular structure being considered. Referring back to the primary circular structure 510 of FIG. 5, edge point pixels associated with edge points facing outwards away from the center point of the primary circular structure within generated coordinate point representation 500 are determined by structural characterization system 110 to be “outer edge points” of primary circular structure 510. For example, the structural characterization system may determine that primary circular structure 510 includes inner edge points 512 and outer edge points 514. In aspects, structural characterization system 110 may be configured to determine the inner and outer edge points, for example, by calculating gradients of the received image to determine which edge points of the generated coordinate representation are facing into a likely center (inner edge points) or facing out from a likely center (outer edge points). As an example, for a received image, described aspects may compute a dot product (or scalar product) of the image gradient and a unit vector along a line joining a point of interest and an estimated center. The dot product may then be normalized to a numerical value between −1 and 1. If the dot product is a negative numerical value, it indicates the point of interest is associated with a first edge that is moving inward (an inner edge) from the estimated center. If the dot product is instead a positive numerical value it indicates the point of interest is associated with a second edge that is moving outward from the estimated center.

As another example, described aspects may be configured to determine edge points based on identifying points where the gradient (first derivative) is at a local maximum, or equivalently, points where the Laplacian (sum of second derivatives) is zero. For example, described aspects may consider the image to be a set of edges that can each be approximated as an error function, where the edge profile in one dimension is given by a formula where “a” is the amplitude of the edge feature, “s” is the width of the edge feature, “x” is the lateral displacement across the edge feature, and “Erf” represents an error function:

$$f ( x ) = a \frac{1}{2} ( 1 + Erf [ \frac{x}{\sqrt{2} s} ] )$$

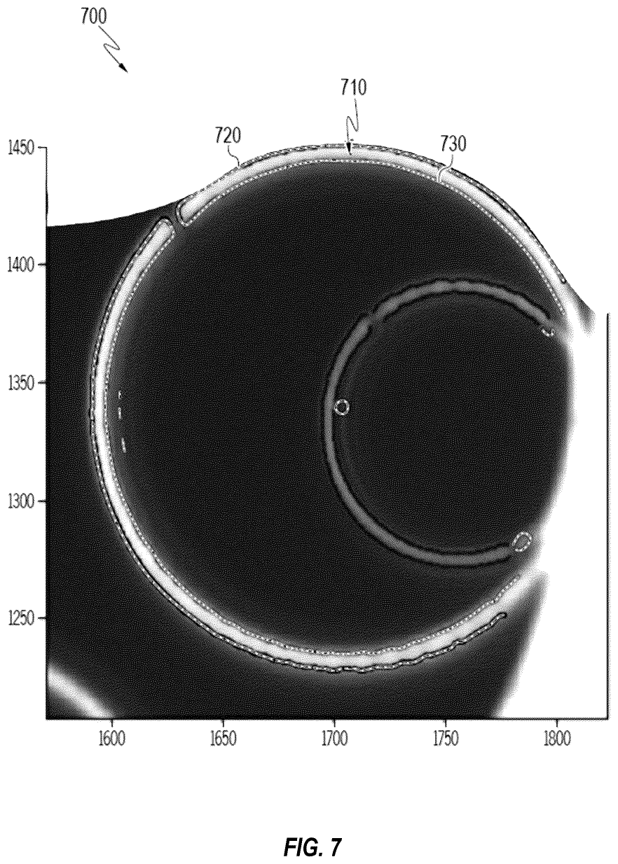

Methods of determining the inner edge points and the outer edge points may be further understood in view of the circular sub-structure depicted in FIG. 7, described in greater detail below in connection with block 318 of illustrative process 300. In FIG. 7, a circular sub-structure 710, corresponding to a capillary (such as capillary 530 of FIG. 5), is shown having highlighted determined outer edge points 720, and highlighted determined inner edge points 730. The determined inner edge points and outer edge points may subsequently be utilized to generate respective best-fit ellipses to approximate the shape of the circular sub-structure 710, as described in greater detail below.

At block 314, structural characterization system 110 generates (for example, using ellipse generating component 136 described above with reference to FIG. 1) a first best-fit ellipse corresponding to a series of inner edge points of the primary circular structure, and second best-fit ellipse corresponding to a series of outer edges points for the primary circular structure. After determining inner edge points and outer edge points for the primary circular structure and removing any extraneous points or noise associated with the inner and outer edge points (at blocks 310 and 312 respectively), structural characterization system 110 generates a first best-fit ellipse corresponding to the series of inner edge points, and a second best-fit ellipse corresponding to the series of outer edge points. As described herein a “best-fit ellipse” refers to an ellipse generated by minimizing a positive-definite error function, or a sum of squares cost function. An example cost function may include a sum of squared geometric distances between the 2D edge points of a coordinate representation for a received image. Another example cost function could include the sum of the squared functional distances between the algebraic representation of a given ellipse and the coordinate points of the coordinate point representation being considered. In certain aspects, the generated best-fit ellipse may be generated based on certain pre-configured constraints on ellipse functional parameters. For example, described aspects may assign non-uniform weights for converging each edge point to an elliptical edge while de-weighting extraneous points.

In another example, described aspects may generate a best-fit ellipse based on the determined edge points by fitting the edge points using a direct linear least-squares method. Described aspects may further employ non-unity point weighting and iteration to eliminate noisy data and converge to the feature boundary.

In certain examples, described aspects further apply several test-fits of the data before performing iterative least squares analyses. For example, in some aspects, the edge points are first fitted to a best-fit circle to find a center and approximate radius. Described aspects may then calculate standard deviations for residuals (i.e. the radial offset between a point and the best-fit circle) of this fit gives the root mean square (RMS) error in the circular estimation. Next, described aspects may then fit the determined edge points to an ellipse with unity weights to give an estimate of the major and minor axes and tilt angle. Described aspects may further be configured to determine initial best-fit ellipse parameters. In some examples, described aspects may be configured to determine the initial best-fit ellipse of an increased size to encourage convergence to a shape that generally surrounds the points, thereby preventing an initial best-fit ellipse that is too small from converging to a shape that passes through sub-structures (e.g. capillaries) rather than surrounding the sub-structures. In certain aspects, the initial best-fit ellipse includes a center from the circular fit, a major axis based on the circular radius plus the ellipticity plus the circular RMS error, the minor axis based on the circular radius minus the ellipticity plus the circular RMS error, and the angle is from the elliptical fit. Described aspects may then calculate weight of each edge point from the residuals (distance between the point and this guess of an elliptical shape) and the dot product of the gradient of the point and the vector from the center to the point using the following formula where “\tilde{r}ᵢ” is the adjusted residual of each point, “σ” is the standard deviation of the residuals, “ĝᵢ” is the image unit gradient vector at a point, and “\hat{n}ᵢ” is the calculated normal vector of the ellipse surface along the line joining the observed point and the ellipse center:

$${w}_{i} = \frac{\vert {\hat{g}}_{i} \cdot {\hat{n}}_{i} \vert}{1 + {( \frac{{\tilde{r}}_{i}}{σ} )}^{4}}$$

Elliptical least squares fit are then iterated by described aspects until convergence, where the weights are re-calculated each iteration using the new residuals “rᵢ”, and the new standard deviation “σ” of the residuals. Described aspects may determine appropriate convergence either when the standard deviation is smaller than a first predetermined threshold, or when the ratio of the standard deviation to the average radius is smaller than a second predetermined threshold, thereby ensuring minimal noise that is smaller than some fraction of the object being fitted. In some examples, described aspects are configured to ensure that the change in the standard deviation of the fit from one iteration to the next is less than a predetermined threshold, thereby ensuring the fit is sufficiently stable.

The above-described techniques for generating best-fit ellipses based on determined edge points are merely illustrative, and described aspects may employ modified techniques including additional or fewer steps as may be useful for characterizing structural and geometric properties of certain optical fibers (or intermediate structures during manufacturing of certain optical fibers).

Structural characterization system 110 can therefore generate a best-fit ellipse that approximates the overall shape and orientation of a given inner or outer edge of a given circular structure, even if the actual shape defined by the inner or outer edges is not perfectly elliptical. The generated best-fit ellipse will thus capture and represent the properties of a given inner edge and outer edge associated with the determined circular primary structure, such as the major and minor axes, center, orientation, and approximate position.

At block 316, structural characterization system 110 detects a circular sub-structure within the generated first best-fit ellipse. For example, after generating, at block 314, first and second best-fit ellipses corresponding to the primary circular structure 510 of FIG. 5, a structure detecting component (such as structure detecting component 138 described above with reference to FIG. 1) of structural characterization system 110 may detect any circular sub-structures within the bounds of the generated first best-fit ellipse. Described aspects may utilize any known methods for concentric circle detection and ellipse detection. For example, described aspects may utilize a modified Hough circle detection algorithm that allows for concentric circles, overlapping or occluded circles, or other desired features. The employed modified Hough circle detection algorithm may further be modified to tailor outputs to geometries associated with optical fibers, rather than a collection of randomly sized ellipses. For the primary circular structure of FIG. 5, structural characterization system 110 may detect a circular sub-structure corresponding to a capillary (such as one of the capillaries of the series of capillaries 530 in FIG. 5) within the generated first-best fit ellipse for the primary circular structure 510.

Next, at blocks 318-324, structural characterization system 110 performs a systematic and iterative or recursive loop in which structural characterization system 110 generates best-fit ellipses for the detected circular sub-structure, and will then detect whether any additional circular sub-structures within the received image have not yet been considered. Structural characterization system 110 then repeats the methods of previously described blocks 310-314 to generate best-fit ellipses for each subsequently detected circular sub-structure in the received image based on the determined series of inner edge points and outer edge points for each respective detected circular sub-structure.

FIGS. 6-8 depict intermediate stages of a detected circular sub-structure corresponding to a capillary (such as one of the capillaries of the series of capillaries 530 of FIG. 5) as it is processed by an illustrative structural characterization system 110 performing described methods in accordance with block 318-324, and will be further referenced and discussed below.

Referring again to FIGS. 3A and 3B, at block 318, structural characterization system 110 detects (for example, using noise detecting component 139 described above with reference to FIG. 1) extraneous points and noise for removal within the detected circular sub-structure. Structural characterization system 110 may detect extraneous points and noise for removal using techniques in accordance with the methods previously described at blocks 304 and 310. For example, consider circular sub-structure 600 of FIG. 6, corresponding to a capillary 430 of the hollow-core optical fiber of FIG. 4. At block 318, structural characterization system 110 detects extraneous points and noise, such as extraneous structure 620 of FIG. 6, and removes them. This prevents any extraneous points or noise from interfering with the quality of generated best-fit ellipses.

At block 320, structural characterization system 110 determines (for example, using edge point determining component 1524 described below with reference to FIG. 15) inner edge points and outer edge points for the detected circular sub-structure. Structural characterization system 110 may determine the inner edge points and outer edge points for the detected circular sub-structure using methods similar to those previously described in connection with block 312. For example, FIG. 7 depicts an intermediate state 700 including a circular sub-structure 710 (corresponding to capillary 610 of FIG. 6). At block 320, structural characterization system 110 determines a series of inner edge points 730 positioned facing inwards towards a center of circular sub-structure 710, and a series of outer edge points 720 positioned facing outwards away from the center of circular sub-structure 710.

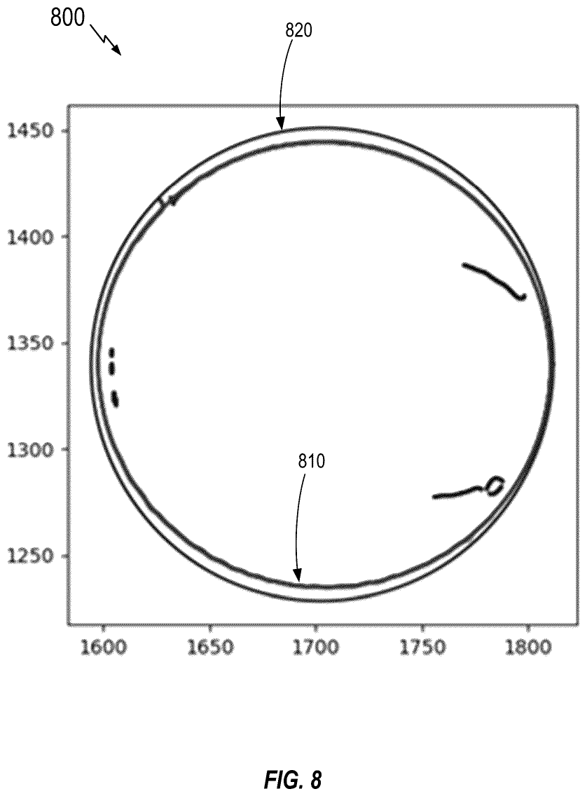

At block 322, structural characterization system 110 generates (for example, using ellipse generating component 136 described above with reference to FIG. 1) best-fit ellipses for the inner edge points and the outer edge points of the circular sub-structure. Structural characterization system 110 may generate best-fit ellipses for the inner edge points and the outer edge points of the circular sub-structure using methods similar to those previously described in connection with block 314. FIG. 8 depicts an intermediate state 800 including an example generated first best-fit ellipse 810 corresponding to the determined inner edge points (previously referenced determined inner edge points 730) of the circular sub-structure (circular sub-structure 710) of FIG. 7. As described, at block 314, structural characterization system 110 then generates a second best-fit ellipse (not shown) for the determined outer edge points 820. Structural characterization system 110 may then leverage the generated first and second best-fit ellipses downstream to measure and calculate various structural and geometric properties of the associated structures of the optical fiber being characterized, as will be described in greater detail below in connection with block 326.

At block 324, structural characterization system 110 detects (for example, using structure detecting component 138 described above with reference to FIG. 1) if there are any additional circular sub-structures within the primary circular sub-structure that have not yet been considered. If structural characterization system 110 detects an additional circular sub-structure, it will return to block 318 to perform described methods of generating first and second best-fit ellipses for the next detected circular sub-structure. If there are no remaining circular-sub structures to be considered, structural characterization system 110 proceeds to block 326.

At block 326, structural characterization system 110 calculates structural properties of the optical fiber using values based on the first best-fit and second best-fit ellipses generated for the primary circular structure, and each of the detected circular sub-structures. In aspects, a structural data calculating component (such as structural data calculating component 140 described above with reference to FIG. 1) of structural characterization system 110 may calculate any useful structural or geometric properties of the optical fiber, or any of the circular sub-structures contained therein, obtainable by leveraging any of the generated first and second best-fit ellipses (corresponding to each circular structure of the fiber) as described herein. For example, structural characterization system 110 may be configured to leverage the generated best-fit ellipses to calculate categories of structural and geometric properties including: enclosed areas, mean diameters, major diameters, minor diameters, angles of a major axis, relative angles of a major axis, ellipticity, core diameter, core ellipticity, X-positions within a coordinate plane, Y-Positions within a coordinate plane, X position relative to a parent structure, Y position relative to a parent structure, radius relative to a parent structure, angle relative to a parent structure, angular error, penetration depth, contact length, contact angle, overlap angle, outer arc length, midline arc length, right-side gap, left-side gap, right-side angle, left-side angle, aspect ratio, average wall thickness, right-side wall thickness, bottom wall thickness, left-side wall thickness, and top-wall thickness. It should be understood that this list of structural and geometric properties that may be calculated using the generated best-fit ellipses is non-limiting and merely illustrative of exemplary categories of measurements and calculations for characterizing a given optical fiber having multiple sub-structures therein.

Certain structural and geometric properties that may be calculated by structural characterization system 110 for a target optical fiber are further described below. It should be understood that various referenced measurements, features, or values associated with described circular structures (or sub-structures) are determined and subsequently leveraged by structural characterization system 110 based on the corresponding generated best-fit rounded shapes. For simplicity, some circular structures and sub-structures may be referred to as known exemplary structures found within fibers, such as substrates, jackets, capillaries, and nested capillaries. It may be understood that an “inner surface” and “outer surface” may refer to respective edges of first and second generated best-fit rounded shapes corresponding to referenced structures. It may be appreciated that certain measurements, features, or values that may be calculated by structural characterization systems in accordance with described aspects are only applicable depending upon the best-fit rounded shape generated by the structural characterization system. For example, described aspects may only calculate “ellipticity” measurements for illustrative examples in which best-fit ellipses are generated for characterization of the structural and geometric properties of a target preform or optical fiber.

As used herein, “angular error” refers to a measure of an angular offset from an ideal angle using, where the “ideal angle” refers to an angle at which the total magnitude of the error of all capillaries is zero due to uniform spacing between each respective capillary. The angular error may refer to at least the angular error of a singular capillary, of a set of outer capillaries, or of a set of nested capillaries. The angular error may be used to describe how uniformly capillaries are positioned. A smaller angular error in a given optical fiber's structure causes less risk of capillaries touching during manufacturing (e.g. during drawing) processes.

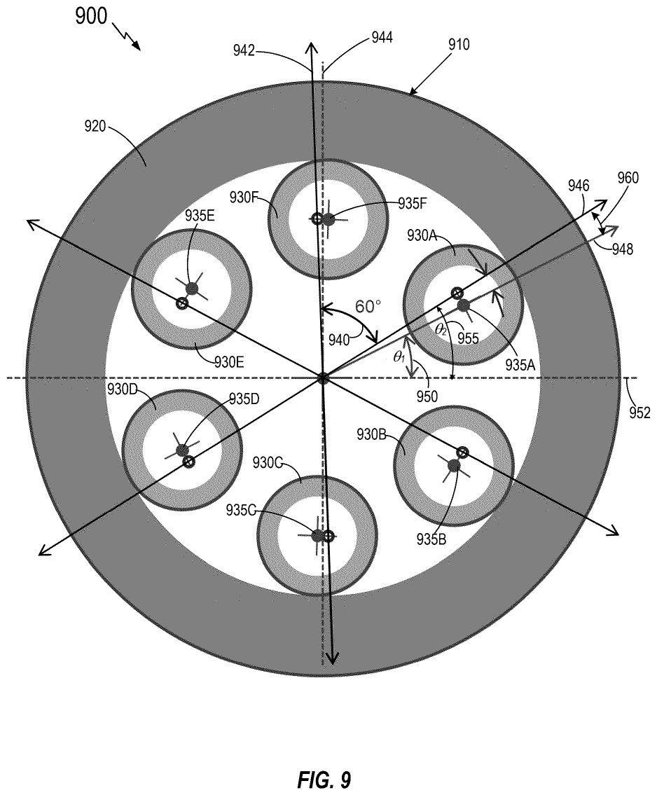

FIG. 9 depicts a diagrammatic view 900 of a portion of a cross-section of an illustrative optical hollow-core fiber 910 including angular error measurements for a capillary.

Optical hollow-core fiber 910 includes a substrate 920 and six capillaries 930A, 930B, 930C, 930D, 930E, and 930F. Each of the six capillaries have a respective corresponding center 935A, 935B, 935C, 935D, 935E, and 935F.

An ideal angle 940 is shown as a 60 degree angle between a first ideal vector 942 extending through an ideal center for capillary 930F, and a second ideal vector 946 extending through an ideal capillary center 931A of capillary 930A. The ideal centers for each respective capillary represent the positions for each capillary center at which the total magnitude of the error for all capillaries of optical hollow-core fiber 910 would be 0. The ideal position of capillary 930A is represented by angle θ₂ at 955, measuring an angle between ideal vector 946 (extending through an ideal capillary center 931A of capillary 930A) and a horizontal axis 952.

An actual angle 950 is represented by θ₁, measuring an angle between a first actual axis 948 extending through a center of capillary 930A, and a horizontal axis 952. Horizontal axis 952 extends perpendicular to a vertical axis 944 (where the respective directions of horizontal axis 952 and vertical axis 944 are defined by an X-Y plane extending parallel to the depicted cross-section of optical hollow-core fiber 910) and through a center of optical hollow-core fiber 910 to form a ninety degree angle.

Accordingly, an angular error 960 for capillary 930A is measured as a numerical value for the angular offset from the ideal angle. For example, angular error 960 may be measured by subtracting actual angle 950 (θ₁) from the ideal angle 955 (θ₂). Described aspects may further be configured to calculate (for example, using structural data calculating component 1530 with reference to FIG. 15) various statistical measures of angular error, such as a mean angular error (e.g. an average angular error for a set of capillaries or sub-structures), a maximum angular error, or a RMS angular error. Described aspects may thus utilize the generated best-fit rounded shapes (as described above with reference to illustrative process 300 of FIG. 3) to measure wall thickness for characterizing structural and geometric properties of various optical fibers at different stages of manufacturing.

As used herein, “penetration depth” refers to at least the distance between points on a line joining an inner surface of a substrate (e.g. a jacket) and an outer surface of an adjacent capillary.

As used herein, “mean diameter” refers to at least the geometric mean of minor and major diameters of a given circular sub-structure.

As used herein, “ellipticity” refers to at least 1 minus the ratio of minor and major diameters of a given sub-structure.

As used herein “contact length” refers to at least the distance between two points where an inner surface of a substrate and an outer surface of a given capillary meet.

As used herein “contact angle” refers to at least the average angle at two points where an outer surface of a given capillary and an inner surface of a substrate cross.

As used herein “overlap angle” refers to at least a central angle between two points where an outer surface of a capillary and inner surface of a substrate cross.

As used herein “wall thickness” refers to at least a distance between a first point on the outer surface of a capillary and a second point on the inner surface that is collinear with the center of the inner surface, measured in 4 directions relative to a line joining the capillary and a substrate. Accordingly, described aspects may generate reports (for example, using output generating component 1532 described below with reference to FIG. 15) detailing an average wall thickness by averaging each of the measurements, or individual wall thickness measurements for a certain region of a capillary (e.g. top, bottom, left, or right with respect to an axis extending along a center of an inner surface of a substrate and a center of the capillary). Wall thickness can affect confinement of a hollow core of a given hollow core fiber. In some examples, wall thickness must be at or near a given value to ensure desired anti-resonant properties are achieved. In certain aspects, wall thickness (i.e. a cladding layer surrounding a core) affects how well light is confined within an optical fiber.

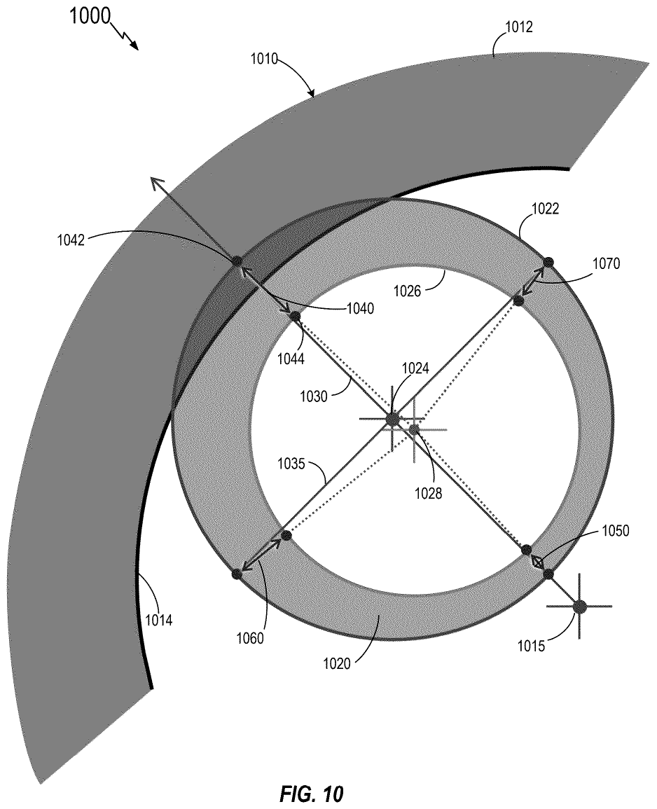

FIG. 10 depicts a diagrammatic view 1000 including wall thickness measurements for a portion of an illustrative optical hollow-core fiber.

View 1000 includes a substrate 1010 having a substrate outer surface 1012, and a substrate inner surface 1014. Substrate inner surface 1014 has a corresponding substrate inner surface center 1015. View 1000 further includes a capillary 1020. Capillary 1020 includes an outer surface 1022 corresponding to an outer surface center 1024. Capillary 1020 further includes an inner surface 1026 corresponding to an inner surface center 1028.

A first axis 1030 is defined by a line extending from substrate inner surface center 1015 through capillary outer surface center 1024. A second axis 1035 is perpendicular to first axis 1030, and similarly extends through capillary outer surface center 1024. A first wall thickness measurement 1040 measures the distance between a first point 1042 on outer surface 1022 of capillary 1020 that intersects with axis 1030, and a second point 1044 on inner surface 1026 of capillary 1020 that is collinear with inner surface center 1028. In certain aspects, the wall thickness measurement 1040 may be referred to as a “top” wall thickness measurement, for measuring a wall thickness of an upper region of capillary 1020 as oriented with reference to first axis 1030 extending away from substrate inner surface center 1015. A second wall thickness measurement 1050, sometimes referred to as a “bottom” wall thickness measurement, is obtained using similar means as described above. As shown, third and fourth wall thickness measurements 1050,1060 are obtained performing similar means as described above, however, the outer surface points are determined based on second axis 1035, such that wall thickness measurement 1050 can measure the wall thickness for a “left” portion of capillary 1020, while wall thickness measurement 1060 can measure the wall thickness for a “right” portion of capillary 1020 as defined with respect to the direction along which first axis 1030 extends towards outer surface 1012 of substrate 1010. Described aspects may thus utilize the generated best-fit rounded shapes (as described above with reference to illustrative process 300 of FIG. 3) to measure wall thickness for characterizing structural and geometric properties of various optical fibers at different stages of manufacturing. As used herein “separation” refers to at least a closest distance between outer surfaces of two adjacent capillaries. Typically, as separation decreases, optical performance (i.e. transmission loss) improves.

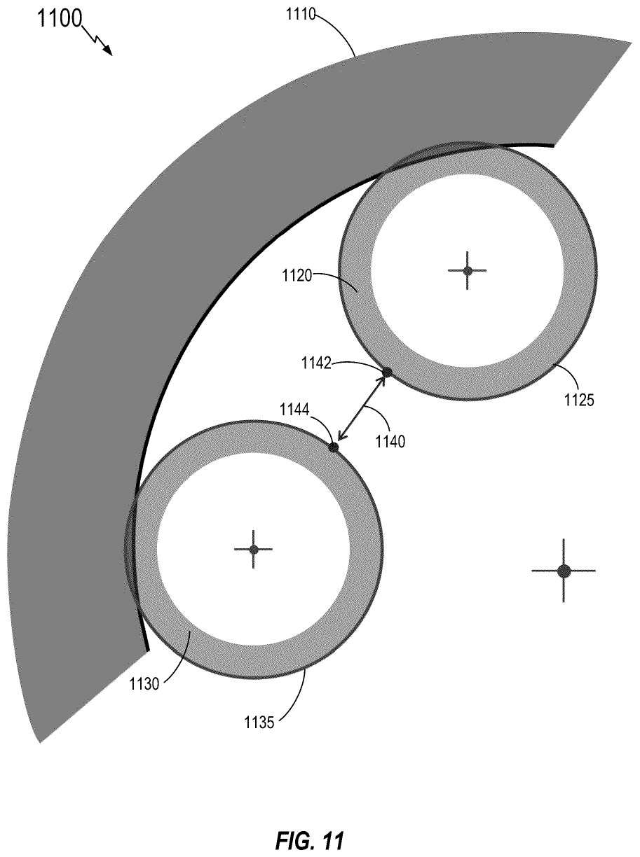

FIG. 11 depicts a diagrammatic view 1100 including separation measurements for a portion of an illustrative optical hollow-core fiber.

View 1100 includes a substrate 1110, a first capillary 1120, and a second capillary 1130. First capillary 1120 has an outer surface 1125. Second capillary 1130 has an outer surface 1135. A separation measurement 1140 measures the distance between a first point 1142 on outer surface 1125 of first capillary 1120, and a second point 1144 on outer surface 1135 of second capillary 1130. As described, separation measurement 1140 uses first point 1142 and second point 1144 because they represent points for measuring the shortest distance between outer surface 1125 of first capillary 1120 and outer surface 1135 of second capillary 1130. Described aspects may thus utilize the generated best-fit rounded shapes (as described above with reference to illustrative process 300 of FIG. 3) to measure separation between outer surfaces of two adjacent capillaries (or other circular structures) for characterizing structural and geometric properties of various optical fibers at different stages of manufacturing.

As used herein “core diameter” refers to at least a mean diameter of a largest rounded shapes that fits within a series of capillaries with the least overlap. In some examples, “Core diameter” may refer to a diameter of a largest circle that is tangent to an inner surface of an outer sub-structure and an outer surface of an inner sub-structure. For example, core diameter may reference a diameter of a largest circle that is tangent to an inner surface of an outer capillary and an outer surface of a corresponding nested capillary therein.

While illustrative process 300 of FIGS. 3A and 3B relates to a described aspect for characterizing structural properties of target preforms or optical fibers based on generated best-fit ellipses, structural characterization systems in accordance with described aspects may instead (or further) be configured to generate and leverage different best-fit rounded shapes. For example, rather than including only an ellipse generating component (such as ellipse generating component 136 of FIG. 1) described structural characterization systems may instead or additionally include any alternative rounded shape generating component (not shown) for utilizing stored programs or instructions (for example based on leveraging instructions and mathematics corresponding to data stored within best fit calculating data 1542 of memory 1512 with reference to FIG. 15) to generate alternative best-fit rounded shapes. For example, a structural characterization system in accordance with described aspects may be configured to utilize a rounded shape generating component for leveraging piecewise polynomial approximation, Fourier series fittings, radial basis functions, or other mathematical approximation techniques for generating various best-fit rounded shapes. In some examples, the structural characterization systems according to described aspects may be configured to generate best-fit ovals for use in calculating structural and geometric properties of a target preform or optical fiber.

In aspects, an output generating component (such as output generating component 150 described with reference to FIG. 1) of structural characterization system 110 may be configured to generate different types of reports incorporating calculated geometric and structural properties from block 326 of illustrative process 300. In aspects, structural characterization system 110 may be configured to generate reports including various outputs such as plots, tables, charts, graphs, or any other useful known outputs to convey the calculated geometric and structural properties for a given target fiber.

FIGS. 12-14 each depict example outputs that may be generated (for example, using output generating component 1532 described below with reference to FIG. 15) by structural characterization systems according to described aspects.

For example, FIG. 12 depicts a first line graph 1200 including structural properties of a preform that can be used to form the optical fiber of FIG. 4 that may be generated using described methods of characterizing structural and geometric properties of a preform or optical fiber according to at least one aspect. As previously discussed, described aspects allow for the use of non-destructive sampling methods, such as X-Ray microtomography, which allow structural characterization system 110 to calculate geometric and structural properties along the length of a target preform or optical fiber. The output generating component of structural characterization system 110 may then generate plots including geometric and structural properties of the primary structure, or the sub-structures of the preform or optical fiber along its length. Graph 1200 depicts mean diameters in millimeters for a series of 6 capillaries of three different preforms plotted on a Y-axis of the graph, plotted against inspection length in millimeters plotted on the X-axis of the graph. This allows a user to easily observe any changes or inconsistencies between the diameters of the different depicted capillaries over the selected length of the preform (e.g. in the structure of a preform before it is drawn to an optical fiber).

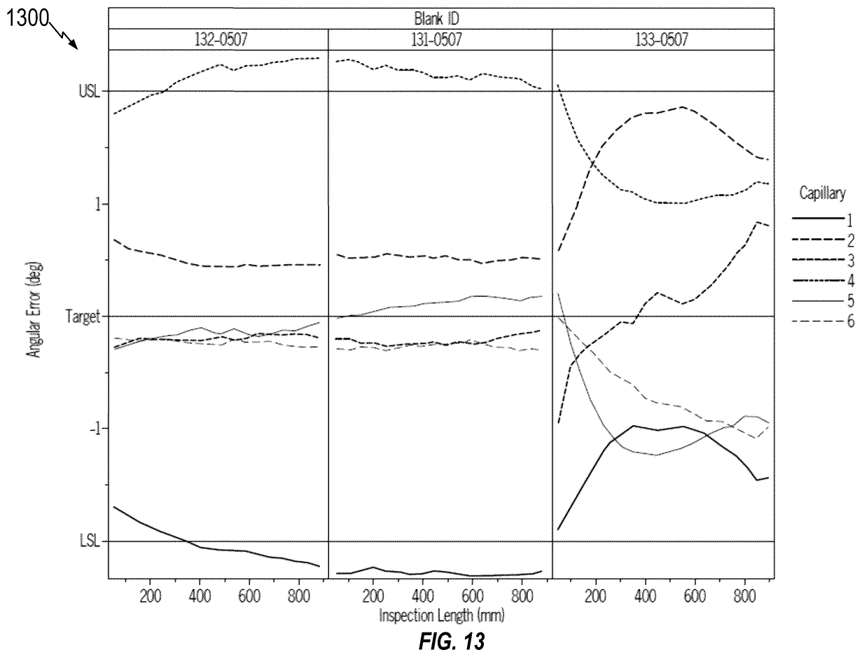

As another example, FIG. 13 depicts a second line graph 1300 including structural properties of a preform that can be used to form the optical fiber of FIG. 4 that may be generated by described methods of characterizing structural and geometric properties of a preform or an optical fiber according to at least one aspect. Graph 1300 depicts angular error in degrees for a series of 6 capillaries of three different preforms plotted on a Y-axis of the graph, plotted against inspection length in millimeters plotted on the X-axis of the graph. The depicted angular error refers to the offset from an ideal angle using uniform spacing, so that the total magnitude of error of all capillaries is zero. This allows a user to easily view which capillaries have actual angles that are undesirably offset from an ideal angle.

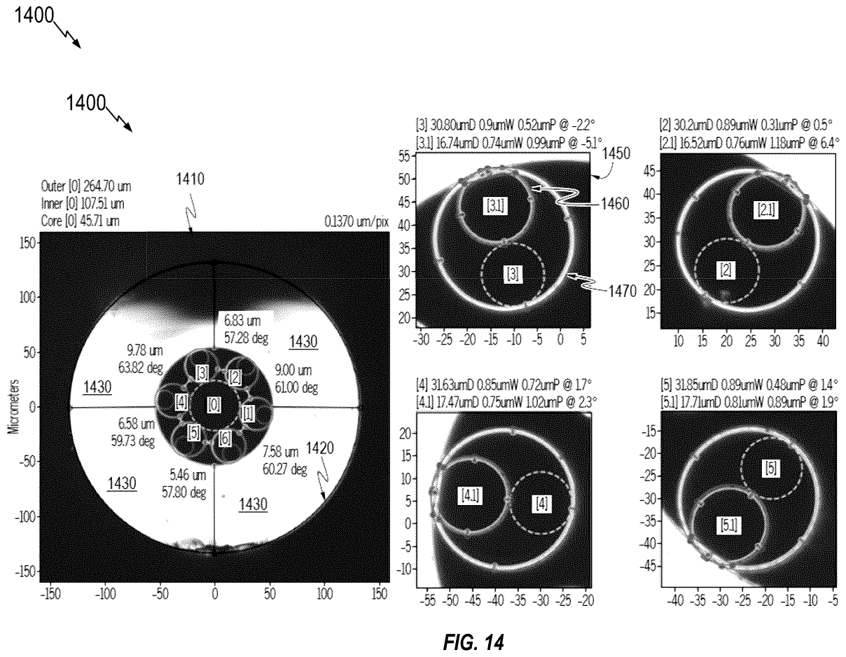

FIG. 14 depicts an example output 1400 of a structural characterization system configured to perform described methods of characterizing structural and geometric properties of a fiber according to at least one aspect. As shown, example output 1400 includes a first window 1410 including a received image, in which a primary circular structure 1420 having a largest diameter is broken up into segments 1430. A center region within primary circular structure 1420 is assigned a reference tag “[0]”, and each detected sub-structure, or capillary, is assigned a reference tag from “[1]” to “[6]” respectively. A set of second windows 1450 demonstrates the ability of structural characterization system 110 to maintain relationships between sub-structures of a given optical fiber by assigning hierarchical reference tags to related sub-structures. For example, a first plotted sub-structure, functioning as a parent, may be assigned a first reference tag. A second plotted sub-structure, positioned within the bounds of the first plotted sub-structure and functioning as a child of the parent, may then be assigned a second reference tag similar to the first reference tag to easily maintain the relationship between the first plotted parent sub-structure, and the second plotted child sub-structure. This functionality is shown more clearly in window 1450 of FIG. 14. As shown, structural characterization system 110 generates plots in which a nested capillary 1460 (a child sub-structure) is shown as being assigned a reference tag “[3.1]”, maintaining a hierarchical relationship with a parent sub-structure corresponding to a capillary 1470 that is assigned a reference tag “[3]”. This feature allows users of structural characterization system 110 to more easily understand the structural organization and spatial relationships between structures within the fiber, facilitating functional analysis, design and optimization, and defect detection and quality control.

FIG. 15 depicts an illustrative processing system 1500 for implementing aspects described herein. In some aspects, processing system 1500 may be a device configured to perform illustrative process 300 of FIGS. 3A and 3B.

Processing system 1500 includes one or more processors 1502. Generally, processor(s) 1502 may be configured to execute computer-executable instructions (e.g., software code) to perform various functions, as described herein.

Processing system 1500 also includes input(s) and output(s) devices 1504, which generally provide means for providing data to and from processing system 1500, such as via connection to computing device peripherals, including user interface peripherals.

Processing system 1500 additionally includes a network interface(s) 1506, which generally provides data access to any sort of data network, including personal area networks (PANs), local area networks (LANs), wide area networks (WANs), the Internet, and the like.

Processing system 1500 further includes a memory 1512 configured to store various types of components and data.

Processing system 1500 furthermore includes a bus 1508, which may generally be configured for data and/or power exchange amongst the components. Bus 1508 may be representative of multiple buses, while only one is depicted for simplicity.

In this example, memory 1512 includes an image receiving component 1514, an image pre-processing component 1516, a coordinate generating component 1518, a structure determining component 1520, a noise removing component 1522, an edge point determining component 1524, a best-fit ellipse generating component 1526, a sub-structure detecting component 1528, a structural data calculating component 1530, and an output generating component 1532.

The image receiving component 1514 is configured to perform at least block 302, shown in FIG. 3A, as described herein.

The image pre-processing component 1516 is configured to perform at least block 304, shown in FIG. 3A, as described herein.

The coordinate generating component 1518 is configured to perform at least block 306, shown in FIG. 3A, as described herein.

The primary structure determining component 1520 is configured to perform at least block 308, shown in FIG. 3A, as described herein.

The noise removing component 1522 is configured to perform at least block 310 shown in FIG. 3A and block 318 shown in FIG. 3B, as described herein.

The edge point determining component 1524 is configured to perform at least block 312 shown in FIG. 3A and block 320 shown in FIG. 3B, as described herein.

The best-fit ellipse generating component 1526 is configured to perform at least block 314 shown in FIG. 3A and block 322 shown in FIG. 3B, as described herein.

The sub-structure detecting component 1528 is configured to perform at least block 316 shown in FIG. 3A and block 324 shown in FIG. 3B, as described herein.

The structural data calculating component 1530 is configured to perform at least block 326, shown in FIG. 3A, as described herein.

In this example, memory 1512 also includes image processing data 1540, best fit calculating data 1542, structural calculation data 1544, and output data 1546.

Processing system 1500 may be implemented in various ways. For example, processing system 1500 may be implemented within on-site, remote, or cloud-based processing equipment.

It will be appreciated by those skilled in the art that other variations of the embodiments described herein may also be practiced without departing from the scope of the invention. Other modifications are therefore possible. For example, in alternative aspects, aspects described with respect to the processing system 1500 may be omitted, added, or substituted for alternative aspects.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or component(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of characterizing an optical fiber, the method comprising:
generating a coordinate point representation of an image comprising a cross-section of the optical fiber, the generated coordinate point representation comprising a series of edge points;
determining, based on the series of edge points, a circular primary structure within the generated coordinate point representation having a largest diameter;
generating a first best-fit rounded shape corresponding to a series of inner edge points and a second best-fit rounded shape corresponding to a series of outer edges points of the circular primary structure;
detecting one or more circular sub-structures within the first best-fit rounded shape;
for each respective detected circular sub-structure of the one or more detected circular sub-structures, generating a series of subsequent best-fit rounded shapes corresponding to respective inner edge points and respective outer edge points of the respective detected circular sub-structure; and
calculating a structural property of the optical fiber using values based on at least one of the generated first best-fit rounded shape, second best-fit rounded shape, and subsequent best-fit rounded shapes.

2. The method of claim 1, further comprising:
pre-processing the image by at least smoothing the image; and
performing derivative filtering of the image.

3. The method of claim 1, further comprising:
detecting noise associated with at least the primary circular structure or one or more of the respective detected circular sub-structures in the generated coordinate point representation; and
removing the detected noise.

4. The method of claim 1, further comprising:
detecting, within the generated coordinate point representation, at least a first plotted sub-structure having a second plotted sub-structure contained within the first plotted sub-structure; and
maintaining a hierarchical relationship between the at least first plotted sub-structure and the second plotted sub-structure by assigning hierarchical reference tags to the first plotted sub-structure and the second plotted sub-structure.

5. The method of claim 1, wherein the image is obtained using a non-destructive sampling method.

6. The method of claim 1, wherein the optical fiber comprises a hollow-core optical fiber.

7. The method of claim 6, wherein the circular sub-structures correspond to one or more of a capillary and a nested capillary of the hollow-core optical fiber.

8. A processing system, comprising: a memory comprising computer-executable instructions; and a processor configured to execute the computer-executable instructions and cause the processing system to:
generate a coordinate point representation of an image comprising a cross-section of an optical fiber, the generated coordinate point representation comprising a series of edge points;
determine, based on the series of edge points, a circular primary structure within the generated coordinate point representation having a largest diameter;
generate a first best-fit rounded shape corresponding to a series of inner edge points and a second best-fit rounded shape corresponding to a series of outer edges points of the circular primary structure;
detect one or more circular sub-structures within the first best-fit rounded shape;
for each respective detected circular sub-structure of the one or more detected circular sub-structures, generate a series of subsequent best-fit rounded shapes corresponding to respective inner edge points and respective outer edge points of the respective detected circular sub-structure; and
calculate a structural property of the optical fiber using values based on at least one of the generated first best-fit rounded shape, second best-fit rounded shape, and subsequent best fit rounded shapes.

9. The processing system of claim 8, wherein the processor is further configured to cause the processing system to:
pre-process the image by at least smoothing the image; and
perform derivative filtering of the image.

10. The processing system of claim 8, wherein the processor is further configured to cause the processing system to:
detect noise associated with at least the primary circular structure or one or more of the respective detected circular sub-structures in the generated coordinate point representation; and
remove the detected noise.

11. The processing system of claim 8, wherein the processor is further configured to cause the processing system to:
detect, within the generated coordinate point representation, at least a first plotted sub-structure having a second plotted sub-structure contained within the first plotted sub-structure; and
maintain a hierarchical relationship between the at least first plotted sub-structure and the second plotted sub-structure by assigning hierarchical reference tags to the first plotted sub-structure and the second plotted sub-structure.

12. The processing system of claim 8, wherein the image is obtained using a non-destructive sampling method and stored in the processing system.

13. The processing system of claim 8, wherein the optical fiber comprises a hollow-core optical fiber.

14. The processing system of claim 13, wherein the circular sub-structures correspond to one or more of a capillary and a nested capillary of the hollow-core optical fiber.

15. A computer program product embodied on a computer-readable medium comprising program code for performing a method, the method comprising:
generating a coordinate point representation of an image comprising a cross-section of an optical fiber, the generated coordinate point representation comprising a series of edge points;
determining, based on the series of edge points, a circular primary structure within the generated coordinate point representation having a largest diameter;
generating a first best-fit rounded shape corresponding to a series of inner edge points and a second best-fit rounded shape corresponding to a series of outer edges points of the circular primary structure;
detecting one or more circular sub-structures within the first best-fit rounded shape;
for each respective detected circular sub-structure of the one or more detected circular sub-structures, generating a series of subsequent best-fit rounded shapes corresponding to respective inner edge points and respective outer edge points of the respective detected circular sub-structure; and
calculating a structural property of the optical fiber using values based on at least one of the generated first best-fit rounded shape, second best-fit rounded shape, and subsequent best fit rounded shapes.

16. The computer program product of claim 15, wherein the method further comprises:
pre-processing the image by at least smoothing the image; and
performing derivative filtering of the image.

17. The computer program product of claim 15, wherein the method further comprises:
detecting noise associated with at least the primary circular structure or one or more of the respective detected circular sub-structures in the generated coordinate point representation; and
removing the detected noise.

18. The computer program product of claim 15, wherein the method further comprises:
detecting, within the generated coordinate point representation, at least a first plotted sub-structure having a second plotted sub-structure contained within the first plotted sub-structure; and
maintaining a hierarchical relationship between the at least first plotted sub-structure and the second plotted sub-structure by assigning hierarchical reference tags to the first plotted sub-structure and the second plotted sub-structure.

19. The computer program product of claim 15, wherein the image is obtained using a non-destructive sampling method and configured to be retrievable by the program code.

20. The computer program product of claim 15, wherein the optical fiber is a hollow-core optical fiber and the circular sub-structures correspond to one or more of a capillary and a nested capillary of the hollow-core optical fiber.
